(19) United States
(12) Patent Application Publication
(10) Pub. No.: US 2004/0017523 A1
(43) Pub. Date: Jan. 29, 2004

(54) Liquid crystal device

(76) Inventor: Tadahiro Asada, Kyoto-shi (JP)

Correspondence Address: OLIFF & BERRIDGE, PLC, P.O. BOX 19928, ALEXANDRIA, VA, 22320, US

(21) Appl. No.: 10/201,778

(22) Filed: Jul. 25, 2002

(51) Int. Cl. G02F 1/1333

(52) U.S. Cl. 349/86

(57) ABSTRACT

A liquid crystal display device that is thin and requires no polarizer. In one embodiment of the liquid crystal display device, light from the light source 13 is collimated and cast to the polydomain cholesteric liquid crystal layer 7 inserted between transparent electrodes 5 and 6. When no voltage is applied between the transparent electrodes 5 and 6, the polydomain cholesteric liquid crystal layer 7 takes the polydomain texture and thus scatters light. In this case, the scattered light is emitted from the transparent electrode 5 outside the liquid crystal cell 8. This is the light-emitting state of the liquid crystal display device. When a voltage is applied between the electrodes 5 and 6, the cholesteric liquid crystal layer 7 takes the homeotropic texture. In this case, the incident light is little scattered and travels straight, whereby very little amount of light is emitted from the transparent electrode 5 outside the liquid crystal cell 8. This makes the dark state of the liquid crystal display device.

The present invention relates to a device for modulating the intensity of light and displaying information by making use of a change in the state of liquid crystal according to the presence or absence of an electric field. This device is referred to as a liquid crystal device in the present specification.

### BACKGROUND OF THE INVENTION

Various liquid crystal devices have been widely used as a light modulator, an optical shutter, a liquid crystal display, etc. Most of these liquid crystal devices include a liquid crystal cell and a pair of polarizers. The liquid crystal cell consists of a pair of plate or film transparent electrodes and liquid crystal in a twisted alignment (or twisted liquid crystal) inserted between them. The polarizers are respectively placed on the outer surfaces of the pair of transparent electrodes. Such liquid crystal devices pass/stop light according to the change in the polarizing characteristic (including optical rotation) of the liquid crystal, which depends on the alignment of the liquid crystal molecules according to the presence or absence of an electric field. These liquid crystal devices are hereinafter referred to as a polarizing type liquid crystal device.

In the polarizing type liquid crystal device, there is a significant energy loss in the illuminating light transmitting through the two polarizers. Therefore, in a liquid crystal display, for example, a powerful backlight is necessary so that the liquid crystal cell can emit an adequate amount of light after such an energy loss. This leads to a large consumption of the electric power. In order to assure a uniform lighting throughout the screen, a backlight is usually composed of a light source such as a fluorescent lamp and a reflector and/or a light guide. With such a structure, a thinner backlight inevitably leads to a less bright and more uneven screen. If, on the other hand, a backlight with a strong light intensity is used, it is difficult to make the liquid crystal display thinner.

### SUMMARY OF THE INVENTION

The above problem is solved by the liquid crystal device according to the present invention which includes:

a liquid crystal cell including a pair of plate or film electrodes and a PCW-LC (Polymer Cell-Wall Type Liquid Crystals) polydomain chiral liquid crystal layer inserted between them, wherein one of the pair of plate or film electrodes on the light-emitting side is transparent; and

a lighting device for irradiating a light from a light source to the polydomain chiral liquid crystal layer from its side.

In the present specification, any of the liquid crystal material whose texture changes between the polydomain texture and the homeotropic texture depending on the presence and absence of an electric field is called “polydomain chiral liquid crystal”, as above. Thus the polydomain chiral liquid crystal in the present specification includes the cholesteric liquid crystal (chiral nematic liquid crystal) and a mixture of cholesteric liquid crystal and chiral smectic C liquid crystal.

Liquid crystal devices using chiral liquid crystal have already been known (for example, a liquid crystal light modulator described in the Japanese Unexamined Patent Publication No. H4-119320, a liquid crystal display device described in the Japanese Unexamined Patent Publication No. H5-88150). Such liquid crystal devices use a liquid crystal cell which includes a pair of transparent plate or film electrodes, and a polydomain chiral liquid crystal layer inserted between them. In this type of liquid crystal devices, when no voltage is applied between the transparent electrodes, the polydomain chiral liquid crystal takes a polydomain focalconic texture and thus scatters light tremendously. Accordingly, light entering from a transparent electrode is mostly blocked by the liquid crystal, which makes the dark state of the liquid crystal cell. When a voltage is applied between the transparent electrodes, on the other hand, the chiral liquid crystal molecules come into a homeotropic alignment. Accordingly, light entering substantially perpendicular to the liquid crystal cell through a transparent electrode can pass through the liquid crystal and come out of the other transparent electrode, which makes the bright state of the liquid crystal cell. Since this type of liquid crystal devices (which is hereinafter referred to as a scattering type liquid crystal device) requires no polarizer, the above-mentioned energy loss in the transmitting light is adequately avoided.

The liquid crystal device according to the present invention includes a liquid crystal cell which includes the above-described polydomain chiral liquid crystal layer, and a lighting device for irradiating a light from a light source to the polydomain chiral liquid crystal layer from its side, which is substantially parallel to the electrodes. In the present liquid crystal device, when a voltage is applied between the electrodes, the chiral liquid crystal molecules come into the homeotropic alignment. Since the light irradiated from the side is little scattered by the liquid crystal and travels straight, little light emerges from the transparent electrode outside the liquid crystal cell, which makes the dark state of the liquid crystal cell. When no voltage is applied between the electrodes, on the other hand, the chiral liquid crystal takes the polydomain texture and thus scatters light. Accordingly, the light irradiated from the side emerges from the transparent electrode outside the liquid crystal cell, which makes the bright state of the liquid crystal cell. This is just opposite to the above-described relationship between the presence/absence of the applied voltage and the dark/bright state of the liquid crystal cell in the scattering type liquid crystal device.

In the liquid crystal device of the present invention, only the light-emitting side electrode needs to be transparent, and the other electrode need not be transparent. It is therefore possible, for example, to make the inner surface of the other non-transparent electrode a mirror. By making both electrodes transparent, a liquid crystal display device of a double sided light-emitting type can be obtained.

In the liquid crystal device of the present invention, the chiral liquid crystal layer may have the structure in which a lot of grains are built up, where each grain (or a tiny envelope) encapsulates a small volume of chiral liquid crystal (having the polydomain texture) with a transparent thin polymer film. Since the incident light is scattered by the grain boundaries as well as by the polydomain texture within every grain, a high light-scattering efficiency can be obtained as a whole.

Since no polarizer is necessary in the liquid crystal device of the present invention, the above-mentioned energy loss in the transmitting light can be prevented. It is therefore possible to use a low-powered light source. This enables a thinner sidelight, and therefore a thinner liquid crystal device.

### BRIEF DESCRIPTION OF THE DRAWINGS

FIG. 1A shows a liquid crystal light-emitting element embodying the present invention when no voltage is applied between the electrodes.

FIG. 1B shows a liquid crystal light-emitting element embodying the present invention when a voltage is applied between the electrodes.

FIG. 2A is a plan view of the liquid crystal display when no voltage is applied and the whole pattern is displayed.

FIG. 2B is a plan view of the liquid crystal display when a voltage is applied and only the central circular part of the whole pattern is displayed.

### DETAILED DESCRIPTION OF A PREFERRED EMBODIMENT

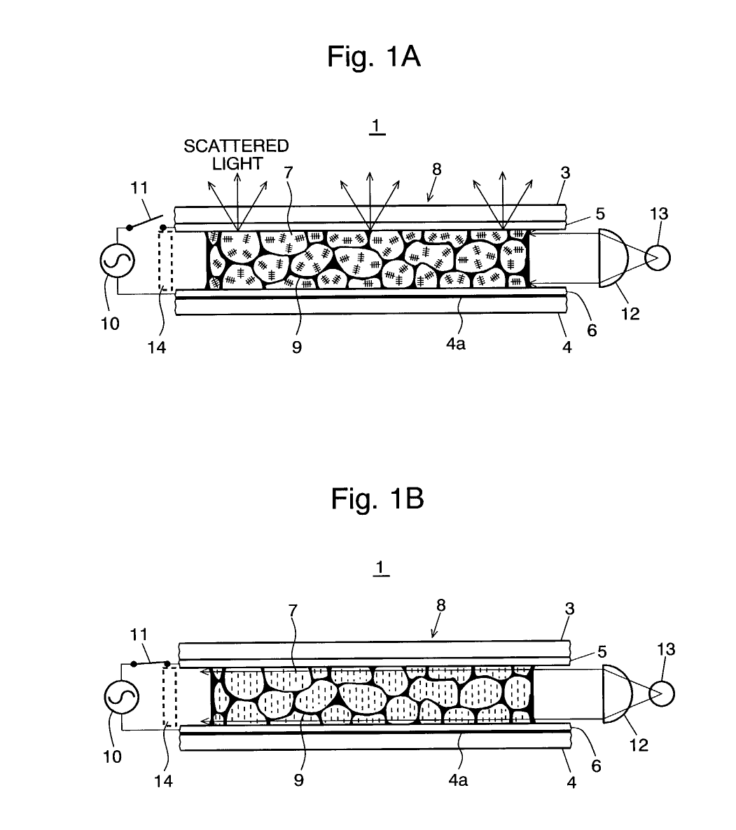

A liquid crystal light-emitting element embodying the liquid crystal display device of the present invention is described referring to FIG. 1. In the present embodiment, a liquid crystal light-emitting element 1 includes a liquid crystal cell 8 consisting of: a pair of glass plates 3 and 4 placed parallel to each other at a certain distance with a spacer (not shown in the drawing); transparent film electrodes 5 and 6 (e.g. Indium Tin Oxide film) laid on the inner surfaces of the glass plates 3 and 4; and a polydomain cholesteric liquid crystal layer 7 inserted between the transparent electrodes 5 and 6. The polydomain cholesteric liquid crystal layer 7 has a structure in which a lot of grains are built up. Each grain encapsulates a small volume of chiral liquid crystal with a transparent thin polymer film 9, and the chiral liquid crystal in each grain has the polydomain texture. The diameter of a grain is about 1 to 2 μm.

Such a structure is obtained, for example, by the following method. Photopolymerizable prepolymer is mixed with the liquid crystal. When the mixture is irradiated by polymerizing light such as ultra-violet rays, the photopolymerizable prepolymer is polymerized and the polymer and the liquid crystal are separated. The polymer becomes thin film and encapsulates a small volume of the liquid crystal. The thickness of the polydomain cholesteric liquid crystal layer 7 is properly set according to the use (or the kind of application) of the liquid crystal light-emitting element 1. For example, it can be determined within a range of 5 to 60 μm. In order to obtain high contrast, low driving voltage, good responsiveness, etc. at high levels, the thickness of the polydomain cholesteric liquid crystal layer 7 is preferably about 5 to 20 μm. It should be noted that, in the drawing, the grains are drawn oversized compared to the thickness of the cholesteric liquid crystal layer 7. The transparent electrodes 5 and 6 are connected to a power source 10 and a switch 11. When the switch 11 is turned on, a voltage is applied between the transparent electrodes 5 and 6. A lens 12 is placed near an end of the liquid crystal cell 8. The lens 12 collimates the light from the light source 13, and the collimated light is sent to the polydomain cholesteric liquid crystal layer 7 inserted between the transparent electrodes 5 and 6. The inner surface 4a of the lower glass plate 4 is made into a mirror by an aluminum deposition.

When the switch 11 is turned off in the liquid crystal light-emitting element 1 of the present embodiment, the polydomain texture is formed in the cholesteric liquid crystal layer 7, as shown in FIG. 1A. The incident light from the lens 12 is scattered by the boundaries 9 of the grains as well as by the polydomain texture of the cholesteric liquid crystal layer 7. The scattered light then goes through the transparent electrode 5 out of the liquid crystal cell 8. This is the light-emitting state of the liquid crystal light-emitting element 1.

When the switch 11 is turned on, a voltage is applied between the transparent electrodes 5 and 6, and the cholesteric liquid crystal layer 7 takes the homeotropic texture, as shown in FIG. 1B. In this case, the incident light from the lens 12 irradiated to a side end of the cholesteric liquid crystal layer 7 is little scattered, whereby the light travels straight and very little amount of light is emitted through the transparent electrode 5 outside of the liquid crystal cell 8. This is the dark state of the liquid crystal light-emitting element 1.

When, in the liquid crystal light-emitting element 1 of the present embodiment, a mirror is placed at the side end 14 of (preferably surrounding) the polydomain cholesteric liquid crystal layer 7, as shown in FIGS. 1A and 1B, less incident light from the light source 13 leaks out of the liquid crystal cell 8 from its circumference and more light goes out of the light-emitting surface when the light is scattered by the polydomain cholesteric liquid crystal layer 7. Accordingly, the liquid crystal cell 8 emits a larger amount of light in the light-emitting state of FIG. 1A.

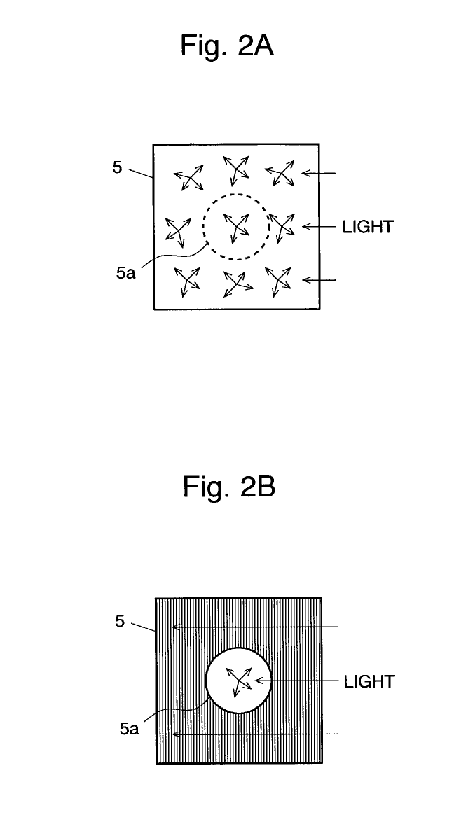

A method of displaying a pattern using the liquid crystal light-emitting element 1 in FIGS. 1A and 1B is described referring to FIGS. 2A and 2B. FIGS. 2A and 2B are a plan view of the transparent electrode 5 of the liquid crystal light-emitting element 1. FIG. 2A shows the state of the transparent electrode 5 when no voltage is applied between the electrodes, and FIG. 2B shows the state of the transparent electrode 5 when a voltage is applied between the electrodes. The transparent electrode 5 has an opening 5 which forms the pattern. When no voltage is applied between the transparent electrodes 5 and 6, the whole of the polydomain cholesteric liquid crystal layer 7 takes the polydomain texture and thus scatters light. Accordingly, as shown in FIG. 2A, the whole surface of the transparent electrode 5 emits the scattered light. When, on the other hand, a voltage is applied between the transparent electrodes 5 and 6, the cholesteric liquid crystal layer 7 beneath the area outside of the opening 5a takes the homeotropic texture, and the incident light is little scattered there but travels straight. This makes the dark state in the area outside the opening 5a. Since the polydomain structure remains owing to no electric field in the opening 5a, the light is scattered there. Accordingly, as shown in FIG. 2B, the pattern of the bright circle in the dark rectangular background is seen on the liquid crystal light-emitting element 1.

As described before, in the above liquid crystal light-emitting element 1 for displaying a pattern, the inner surface 4a of the glass substrate 4 is made into a mirror. The inner surface 4a of the glass substrate 4, however, can also be colored. In this case, the pattern can be changed to a bright circle in a colored rectangular background. It is also possible to put a color filter between the light source 13 and the liquid crystal cell 8. In this case, a colored light is introduced into the liquid crystal cell 8, and the color of the light emitting from the circle is changed. Thus a variety of combinations of the background color and the emitting light color can be made, and, among them, a high-contrast display pattern is realized.

What is claimed is:

1. A liquid crystal device comprising:
a liquid crystal cell including a pair of plate or film electrodes and a polydomain chiral liquid crystal layer inserted between them, wherein one of the pair of plate or film electrodes on the light-emitting side is transparent; and
a lighting means for irradiating a light from a light source to the polydomain chiral liquid crystal layer from its side.

2. The liquid crystal device according to claim 1, wherein the chiral liquid crystal layer has a structure in which a plurality of grains are built up, each of the grains encapsulates a small volume of polydomain chiral liquid crystal with a transparent thin polymer film, and the chiral liquid crystal has a polydomain texture.

3. The liquid crystal device according to claim 1, wherein a thickness of the chiral liquid crystal layer is 5 to 60 μm.

4. The liquid crystal device according to claim 3, wherein a thickness of the chiral liquid crystal layer is 5 to 20 μm.

5. The liquid crystal device according to claim 2, wherein an inner surface of a glass plate on a non-light-emitting side is made into a mirror.

6. The liquid crystal device according to claim 2, wherein a mirror is placed at an end of the polydomain chiral liquid crystal layer.

7. The liquid crystal device according to claim 2, wherein a mirror is placed surrounding the polydomain chiral liquid crystal layer.

8. The liquid crystal device according to claim 2, wherein a pattern of an opening or openings is formed in said one of the pair of plate or film electrodes on the light-emitting side so that no voltage is applied in the opening or openings.

9. The liquid crystal device according to claim 8, wherein an inner surface of a glass plate on a non-light-emitting side is made into a mirror.

10. The liquid crystal device according to claim 8, wherein an inner surface of a glass plate on a non-light-emitting side is colored.

11. The liquid crystal device according to claim 10, wherein a color filter is put between the lighting means and the polydomain chiral liquid crystal layer.
